(19) United States
(12) Patent Application Publication
(10) Pub. No.: US 2021/0203010 A1
(43) Pub. Date: Jul. 1, 2021

(54) AQUEOUS BATTERY

(71) Applicant: TOYOTA JIDOSHA KABUSHIKI KAISHA, Toyota-shi (JP)

(72) Inventor: Hiroshi SUYAMA, Mishima-shi (JP)

(73) Assignee: TOYOTA JIDOSHA KABUSHIKI KAISHA, Toyota-shi (JP)

(21) Appl. No.: 17/117,783

(22) Filed: Dec. 10, 2020

(30) Foreign Application Priority Data
Dec. 25, 2019 (JP) 2019-234733

(51) Int. Cl. H01M 10/36; H01M 4/38

(52) U.S. Cl. CPC H01M 10/36; H01M 2004/027; H01M 4/38

(57) ABSTRACT

A novel aqueous battery configured to use sulfuric acid ions (SO₄²⁻) as carrier ions. The aqueous battery is an aqueous battery comprising a cathode layer, an anode layer and an aqueous liquid electrolyte, wherein the cathode layer contains, as a cathode active material, a graphite; wherein the anode layer contains, as an anode active material, at least one selected from the group consisting of an elemental Zn, an elemental Cd, an elemental Fe, an elemental Sn, a Zn alloy, a Cd alloy, an Fe alloy, an Sn alloy, ZnSO₄, CdSO₄, FeSO₄ and Sn₅O₄; wherein, as an electrolyte, at least one sulfate selected from the group consisting of ZnSO₄, CdSO₄, FeSO₄ and Sn₅O₄ is dissolved in the aqueous liquid electrolyte; and wherein the aqueous liquid electrolyte has a pH of 3 or more and 14 or less.

### TECHNICAL FIELD

The disclosure relates to an aqueous battery.

### BACKGROUND

In recent years, with the rapid spread of IT and communication devices such as personal computers, camcorders and cellular phones, great importance has been attached to the development of batteries that is usable as the power source of such devices.

Patent Literature 1 discloses a dual-ion secondary battery which uses graphite in the cathode and which uses insertion and extraction reactions of TFSI anions (N(SO₂CF₃)₂⁻) between the graphite layers.
Patent Literature 1: Japanese Patent Application Laid-Open No. 2019-029077

For resource saving of battery raw materials and for reduction of battery production costs, there is a demand for the development of a novel aqueous battery configured to use sulfuric acid ions (SO₄²⁻) as carrier ions.

### SUMMARY

The disclosed embodiments were achieved in light of the above circumstances. A main object of the disclosed embodiments is to provide a novel aqueous battery configured to use sulfuric acid ions (SO₄²⁻) as carrier ions.

In a first embodiment, there is provided an aqueous battery comprising a cathode layer, an anode layer and an aqueous liquid electrolyte, wherein the cathode layer contains, as a cathode active material, a graphite;

wherein the anode layer contains, as an anode active material, at least one selected from the group consisting of an elemental Zn, an elemental Cd, an elemental Fe, an elemental Sn, a Zn alloy, a Cd alloy, an Fe alloy, an Sn alloy, ZnSO₄, CdSO₄, FeSO₄ and Sn₅O₄;

wherein, as an electrolyte, at least one sulfate selected from the group consisting of ZnSO₄, CdSO₄, FeSO₄ and Sn₅O₄ is dissolved in the aqueous liquid electrolyte; and wherein the aqueous liquid electrolyte has a pH of 3 or more and 14 or less.

In the aqueous battery of the disclosed embodiments, the anode active material may be at least one selected from the group consisting of an elemental Zn, a Zn alloy and ZnSO₄, and the sulfate may be ZnSO₄; the anode active material may be at least one selected from the group consisting of an elemental Cd, a Cd alloy and CdSO₄, and the sulfate may be CdSO₄; the anode active material may be at least one selected from the group consisting of an elemental Fe, an Fe alloy and FeSO₄, and the sulfate may be FeSO₄; or the anode active material may be at least one selected from the group consisting of an elemental Sn, an Sn alloy and Sn₅O₄, and the sulfate may be Sn₅O₄.

In the aqueous battery of the disclosed embodiments, the anode active material may be at least one selected from the group consisting of an elemental Zn, a Zn alloy and ZnSO₄.

According to the disclosed embodiments, the novel aqueous battery configured to use sulfuric acid ions (SO₄²⁻) as carrier ions, is provided.

### BRIEF DESCRIPTION OF THE DRAWINGS

In the accompanying drawings,

FIG. 1 is a schematic sectional view of an example of the aqueous battery of the disclosed embodiments;

FIG. 2 is a schematic view of the reaction mechanism of a graphite-ZnSO₄ aqueous battery;

FIG. 3 is a cyclic voltammogram of the third cycle of 10 CV cycles carried out at 10 mV/s on the cathode-side evaluation cell of Example 1, the cell comprising a ZnSO₄ aqueous solution at a concentration of 1 mol/kg;

FIG. 4 is a cyclic voltammogram of the third cycle of 10 CV measurement cycles carried out at 10 mV/s on the anode-side evaluation cell of Example 1, the cell comprising a ZnSO₄ aqueous solution at a concentration of 1 mol/kg;

FIG. 5 is a cyclic voltammogram of the third cycle of 10 CV cycles carried out at 10 mV/s on the cathode-side evaluation cell of Example 2, the cell comprising a ZnSO₄ aqueous solution at a concentration of 2 mol/kg;

FIG. 6 is a cyclic voltammogram of the third cycle of 10 CV measurement cycles carried out at 10 mV/s on the anode-side evaluation cell of Example 2, the cell comprising a ZnSO₄ aqueous solution at a concentration of 2 mol/kg;

FIG. 7 is a cyclic voltammogram of the third cycle of 10 CV cycles carried out at 10 mV/s on the cathode-side evaluation cell of Example 3, the cell comprising a ZnSO₄ aqueous solution at a concentration of 3 mol/kg;

FIG. 8 is a cyclic voltammogram of the third cycle of 10 CV measurement cycles carried out at 10 mV/s on the anode-side evaluation cell of Example 3, the cell comprising a ZnSO₄ aqueous solution at a concentration of 3 mol/kg;

FIG. 9 is a cyclic voltammogram of the third cycle of 10 CV cycles carried out at 10 mV/s on the cathode-side evaluation cell of Example 4, the cell comprising a ZnSO₄ aqueous solution at a concentration of 4 mol/kg;

FIG. 10 is a cyclic voltammogram of the third cycle of 10 CV measurement cycles carried out at 10 mV/s on the anode-side evaluation cell of Example 4, the cell comprising a ZnSO₄ aqueous solution at a concentration of 4 mol/kg;

FIG. 11 is a cyclic voltammogram of the 20th cycle of 20 CV cycles carried out at 10 mV/s on the cathode-side evaluation cell of Example 5, the cell comprising a natural graphite-applied electrode and a ZnSO₄ aqueous solution at a concentration of 4 mol/kg;

FIG. 12 is a cyclic voltammogram of the third cycle of 10 CV cycles carried out at 10 mV/s on the cathode-side evaluation cell of Example 6, the cell comprising an aqueous solution containing KOH at a concentration of 1 mol/L and ZnSO₄ at a concentration of 1 mol/kg; and

FIG. 13 is a cyclic voltammogram of the third cycle of 10 CV measurement cycles carried out at 10 mV/s on the anode-side evaluation cell of Example 6, the cell comprising an aqueous solution containing KOH at a concentration of 1 mol/L and ZnSO₄ at a concentration of 1 mol/kg.

### DETAILED DESCRIPTION

The aqueous battery of the disclosed embodiments is an aqueous battery comprising a cathode layer, an anode layer and an aqueous liquid electrolyte,

wherein the cathode layer contains, as a cathode active material, a graphite;

wherein the anode layer contains, as an anode active material, at least one selected from the group consisting of an elemental Zn, an elemental Cd, an elemental Fe, an elemental Sn, a Zn alloy, a Cd alloy, an Fe alloy, an Sn alloy, ZnSO₄, CdSO₄, FeSO₄ and Sn₅O₄;

wherein, as an electrolyte, at least one sulfate selected from the group consisting of ZnSO₄, CdSO₄, FeSO₄ and Sn₅O₄ is dissolved in the aqueous liquid electrolyte; and

wherein the aqueous liquid electrolyte has a pH of 3 or more and 14 or less.

A hermetically-closed aqueous battery using a zinc-based material as the anode active material, generally uses Ni(OH)₂ as the cathode active material. However, Ni is a costly raw material and is not abundant. Since battery applications require high-purity Ni, there is possibility that the supply of Ni decreases in the future and Ni resources are depleted.

The aqueous battery in which, as an alternative to Ni, graphite is used as the cathode active material, will be discussed. It is popular to use imide salt as an electrolyte which contains such anions that exhibit high reaction activity to the extraction and insertion reactions of the anions between the graphite layers. However, the imide salt used as the electrolyte is expensive. For an aqueous liquid electrolyte containing KOH, NaOH or the like as the electrolyte, the oxidation-side potential window is narrow, and it is difficult to suppress an oxygen evolution reaction which occurs as a side reaction when the aqueous battery is charged/discharged.

For the aqueous battery using graphite as the cathode active material and using extraction and insertion reactions of sulfuric acid ions between the graphite layers, it was found that the aqueous battery functions as a battery by using a specific metal material as the anode active material, using an aqueous liquid electrolyte that contains a specific type of sulfate, and controlling the pH of the aqueous liquid electrolyte in a specific range.

Since the aqueous battery of the disclosed embodiments uses graphite, which is an abundant resource, and uses sulfate, which is an inexpensive raw material, as the electrolyte, the production cost can be reduced compared to conventional aqueous batteries, and the aqueous battery contributes to resource saving.

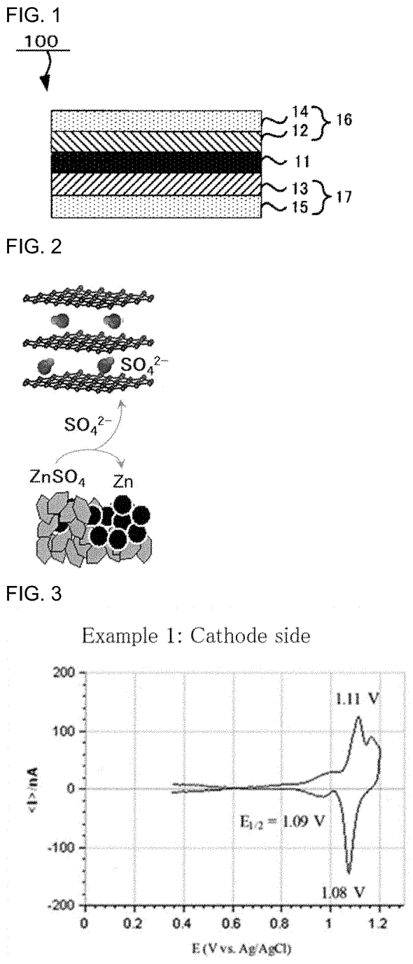

FIG. 1 is a schematic sectional view of an example of the aqueous battery of the disclosed embodiments. An aqueous battery 100, which is an example of the aqueous battery of the disclosed embodiments, comprises: a cathode 16 comprising a cathode layer 12 and a cathode current collector 14, an anode 17 comprising an anode layer 13 and an anode current collector 15, and an aqueous liquid electrolyte 11 disposed between the cathode 16 and the anode 17.

As shown in FIG. 1, the anode 17 is present on one surface of the aqueous liquid electrolyte 11, and the cathode 16 is present on the other surface of the aqueous liquid electrolyte 11. In the aqueous battery, the cathode 16 and the anode 17 are in contact with the aqueous liquid electrolyte 11 for use. The aqueous battery of the disclosed embodiments is not limited to this example. For example, a separator may be disposed between the anode layer 13 and cathode layer 12 of the aqueous battery 100 of the disclosed embodiments. The separator, the anode layer 13 and the cathode layer 12 may be impregnated with the aqueous liquid electrolyte 11. The aqueous liquid electrolyte 11 may impregnate the inside of the anode layer 13 and the cathode layer 12, and the aqueous liquid electrolyte 11 may be in contact with the anode current collector 15 and the cathode current collector 14.

(1) Cathode

The cathode comprises at least the cathode layer. As needed, it further comprises the cathode current collector.

The cathode layer contains at least the cathode active material. As needed, it may contain a conductive additive, a binder, etc.

As the cathode active material, a graphite may be used.

The type of the graphite is not particularly limited. As the graphite, examples include, but are not limited to, a natural graphite, a pyrolytic graphite, a highly oriented pyrolytic graphite (HOPG) and an artificial graphite. The graphite may be at least one of a natural graphite and a highly oriented pyrolytic graphite (HOPG).

The form of the graphite may be a particulate form. In this case, the particulate form is not particularly limited, and it may be a spherical particulate form, a flaky form, or the like.

The average particle diameter of the graphite particles is not particularly limited and may be 1 nm or more and 100 μm or less.

In the disclosed embodiments, unless otherwise noted, the average particle diameter of particles is a volume-based median diameter (D50) measured by laser diffraction/scattering particle size distribution measurement. Also in the disclosed embodiments, the median diameter (D50) of particles is a diameter at which, when particles are arranged in ascending order of their particle diameter, the accumulated volume of the particles is half (50%) the total volume of the particles (volume average diameter).

The cathode active material may contain a cathode active material other than the graphite, to the extent that can achieve the above-mentioned object. However, from the viewpoint of more efficient insertion and extraction of sulfuric acid ions between the graphite layers of the aqueous battery, the cathode active material may be composed of the graphite.

The amount of the cathode active material contained in the cathode layer is not particularly limited. For example, when the whole cathode layer is determined as a reference (100 mass %), the cathode active material may be 10 mass % or more. The upper limit of the amount is not particularly limited and may be 100 mass % or less. When the content of the cathode active material is in such a range, the cathode layer can obtain excellent ion conductivity and electron conductivity.

As the conductive additive, a known material may be used. As the conductive additive, examples include, but are not limited to, a carbonaceous material. The carbonaceous material may be at least one selected from the group consisting of carbon black such as Acetylene Black and furnace black, vapor-grown carbon fiber (VGCF), carbon nanotube and carbon nanofiber.

Also, a metal material that is able to withstand battery usage environments, may be used. As the metal material, examples include, but are not limited to, Ni, Cu, Fe and SUS.

The conductive additive may be one kind of conductive additive or may be a combination of two or more kinds of conductive additives.

The form of the conductive additive may be selected from various kinds of forms such as a powdery form and a fiber form.

The amount of the conductive additive contained in the cathode layer is not particularly limited. In the aqueous battery of the disclosed embodiments, as described above, since the graphite with excellent electroconductivity is used as the cathode active material, excellent electron conductivity can be achieved without a further increase in the amount of the conductive additive.

The binder can be selected from binders that are generally used in aqueous batteries. As the binder, examples include, but are not limited to, styrene-butadiene rubber (SBR), carboxymethyl cellulose (CMC), acrylonitrile-butadiene rubber (ABR), butadiene rubber (BR), polyvinylidene fluoride (PVDF) and polytetrafluoroethylene (PTFE).

The binder may be one kind of binder or may be a combination of two or more kinds of binders.

The amount of the binder contained in the cathode layer is not particularly limited. For example, when the whole cathode layer is determined as a reference (100 mass %), the lower limit of the binder amount may be 0.1 mass % or more. The upper limit of the binder amount is not particularly limited and may be 50 mass % or less. When the content of the binder is in such a range, the cathode layer can obtain excellent ion conductivity and electron conductivity.

The thickness of the cathode layer is not particularly limited. For example, it may be 0.1 μm or more and 1 mm or less.

The cathode current collector functions to collect current from the cathode layer. As the material for the cathode current collector, examples include, but are not limited to, a metal material containing at least one element selected from the group consisting of Ni, Al, Au, Pt, Fe, Ti, Co and Cr. As long as the surface of the cathode current collector is composed of the material, the inside of the cathode current collector may be composed of a material that is different from the surface.

The form of the cathode current collector may be selected from various kinds of forms such as a foil form, a plate form, a mesh form and a perforated metal form.

The cathode may further comprise a cathode lead connected to the cathode current collector.

(2) Anode

The anode comprises the anode layer and the anode current collector for collection of current from the anode layer.

The anode layer contains at least an anode active material. As needed, it may contain a conductive additive, a binder, etc.

The aqueous battery of the disclosed embodiments uses the oxidation-reduction reaction of the anode active material to charge and discharge.

As the anode active material, examples include, but are not limited to, an elemental Zn, an elemental Cd, an elemental Fe, an elemental Sn, a Zn alloy, a Cd alloy, an Fe alloy, an Sn alloy, ZnSO₄, CdSO₄, FeSO₄ and Sn₅O₄. From the viewpoint of increasing the battery voltage of the aqueous battery, the anode active material may be an elemental Zn, a Zn alloy, ZnSO₄ or the like. When the aqueous battery is charged and discharged, these materials can cause an oxidation-reduction reaction with the aqueous liquid electrolyte containing, as the electrolyte, at least one sulfate selected from the group consisting of ZnSO₄, CdSO₄, FeSO₄ and Sn₅O₄. Accordingly, the aqueous battery comprising the graphite as the cathode active material, these materials as the anode active material, and the aqueous liquid electrolyte containing at least one sulfate selected from the group consisting of ZnSO₄, CdSO₄, FeSO₄ and Sn₅O₄ as the electrolyte, is thought to function as a battery.

From the viewpoint of increasing the charge-discharge efficiency of the aqueous battery, the type of the anode active material and the type of the sulfate used as the electrolyte may be selected so that the metal element which is contained in the anode active material and which turns into a cation in the aqueous liquid electrolyte (that is, Zn, Cd, Fe, Sn, etc.) is the same metal element as the metal element which is contained in the sulfate used as the above-described electrolyte and which turns into a cation in the aqueous liquid electrolyte (that is, Zn, Cd, Fe, Sn, etc.)

For example, when the anode active material is at least one Zn-based material selected from the group consisting of an elemental Zn, a Zn alloy and ZnSO₄, the sulfate may be ZnSO₄.

When the anode active material is at least one Cd-based material selected from the group consisting of an elemental Cd, a Cd alloy and CdSO₄, the sulfate may be CdSO₄.

When the anode active material is at least one Fe-based material selected from the group consisting of an elemental Fe, an Fe alloy and FeSO₄, the sulfate may be FeSO₄.

When the anode active material is at least one Sn-based material selected from the group consisting of an elemental Sn, an Sn alloy and SnSO₄, the sulfate may be SnSO₄.

From the viewpoint of further increasing the charge-discharge efficiency of the aqueous battery, the anode active material may be at least one selected from the group consisting of an elemental Zn, a Zn alloy and ZnSO₄, and the sulfate may be ZnSO₄.

When ZnSO₄ is used as the anode active material, from the viewpoint of obtaining excellent electron conductivity and suppressing an oxygen evolution reaction arising from the oxidative decomposition of water when the aqueous battery is over-discharged, at least one of an elemental Zn and a Zn alloy may be further used as the anode active material; they may be mixed to obtain a mixture of the ZnSO₄ and the at least one of an elemental Zn and a Zn alloy; and the mixture may be used as the anode active material. The content of the ZnSO₄ in the mixture is not particularly limited, and it may be 50 mass % or more and 99 mass % or less. The Zn alloy is not particularly limited, as long as it contains a Zn element of 50 atomic % or more.

When CdSO₄ is used as the anode active material, from the viewpoint of obtaining excellent electron conductivity and suppressing an oxygen evolution reaction arising from the oxidative decomposition of water when the aqueous battery is over-discharged, at least one of an elemental Cd and a Cd alloy may be further used as the anode active material; they may be mixed to obtain a mixture of the CdSO₄ and the at least one of an elemental Cd and a Cd alloy; and the mixture may be used as the anode active material. The content of the CdSO₄ in the mixture is not particularly limited, and it may be 50 mass % or more and 99 mass % or less. The Cd alloy is not particularly limited, as long as it contains a Cd element of 50 atomic % or more.

When FeSO₄ is used as the anode active material, from the viewpoint of obtaining electron conductivity and suppressing an oxygen evolution reaction arising from the oxidative decomposition of water when the aqueous battery is over-discharged, at least one of an elemental Fe and an Fe alloy may be further used as the anode active material; they may be mixed to obtain a mixture of the FeSO₄ and the at least one of an elemental Fe and an Fe alloy, and the mixture may be used as the anode active material. The content of the FeSO₄ in the mixture is not particularly limited, and it may be 50 mass % or more and 99 mass % or less. The Fe alloy is not particularly limited, as long as it contains an Fe element of 50 atomic % or more.

When SnSO₄ is used as the anode active material, from the viewpoint of obtaining electron conductivity and suppressing an oxygen evolution reaction arising from the oxidative decomposition of water when the aqueous battery is over-discharged, at least one of an elemental Sn and an Sn alloy may be further used as the anode active material; they may be mixed to obtain a mixture of the Sn₅O₄ and the at least one of an elemental Sn and an Sn alloy, and the mixture may be used as the anode active material. The content of the Sn₅O₄ in the mixture is not particularly limited, and it may be 50 mass % or more and 99 mass % or less. The Sn alloy is not particularly limited, as long as it contains an Sn element of 50 atomic % or more.

The form of the anode active material is not particularly limited. As the form, examples include, but are not limited to, a particulate form and a plate form. When the anode active material is in a particulate form, the average particle diameter of the anode active material particles may be 1 nm or more and 100 μm or less. When the average particle diameter of the anode active material particles is in such a range, the anode layer can obtain excellent ion conductivity and electron conductivity.

The amount of the anode active material contained in the anode layer is not particularly limited. For example, when the whole anode layer is determined as a reference (100 mass %), the anode active material may be 10 mass % or more. The upper limit of the amount is not particularly limited and may be 99 mass % or less. When the content of the anode active material is in such a range, the anode layer can obtain excellent ion conductivity and electron conductivity.

The types of the conductive additive and binder contained in the anode layer are not particularly limited. For example, they can be appropriately selected from those exemplified above as the conductive additive and binder contained in the cathode layer.

The amount of the conductive additive contained in the anode layer is not particularly limited. For example, when the whole anode layer is determined as a reference (100 mass %), the conductive additive may be 1 mass % or more. The upper limit of the amount is not particularly limited and may be 90 mass % or less. When the content of the conductive additive is in such a range, the anode layer can obtain excellent ion conductivity and electron conductivity.

The amount of the binder contained in the anode layer is not particularly limited. For example, when the whole anode layer is determined as a reference (100 mass %), the binder may be 1 mass % or more. The upper limit of the amount is not particularly limited and may be 90 mass % or less. When the content of the binder is in such a range, the anode active material and so on can appropriately bind to each other, and the anode layer can obtain excellent ion conductivity and electron conductivity.

The thickness of the anode layer is not particularly limited. For example, it may be 0.1 μm or more and 1 mm or less.

For the aqueous battery of the disclosed embodiments, the material for the anode current collector may be at least one kind of metal material selected from the group consisting of Zn, Sn and Ti. These metal materials have a work function of 4.5 eV or less. In the case of using the metal material having a work function of 4.5 eV or less, hydrogen evolution arising from the reductive decomposition of water, can be suppressed, and the metal material can be deposited in the form of metal when the aqueous battery is charged. As long as the surface of the anode current collector is composed of the metal material, the inside of the anode current collector may be composed of a material that is different from the surface (for example, in addition to the metal material such as Zn, Sn and Ti, a metal material such as Cu and Fe).

As the form of the anode current collector, examples include, but are not limited to, a foil form, a plate form, a mesh form, a perforated metal form and a foam form.

(3) Aqueous Liquid Electrolyte

The solvent of the aqueous liquid electrolyte contains water as a main component. That is, when the whole amount of the solvent (a liquid component) constituting the aqueous liquid electrolyte is determined as a reference (100 mol %), the water may account for 50 mol % or more, 70 mol % or more, or 90 mol % or more. On the other hand, the upper limit of the proportion of the water in the solvent is not particularly limited.

Although the solvent contains water as the main component, it may contain a solvent other than water. As the solvent other than water, examples include, but are not limited to, one or more selected from the group consisting of ethers, carbonates, nitriles, alcohols, ketones, amines, amides, sulfur compounds and hydrocarbons. When the whole amount of the solvent (the liquid component) constituting the aqueous liquid electrolyte is determined as a reference (100 mol %), the solvent other than water may be 50 mol % or less, may be 30 mol % or less, or may be 10 mol % or less.

The aqueous liquid electrolyte used in the disclosed embodiments contains an electrolyte.

As the electrolyte, examples include, but are not limited to, sulfates such as ZnSO₄, CdSO₄, FeSO₄ and Sn₅O₄. From the viewpoint of increasing the battery voltage of the aqueous battery, the electrolyte may be ZnSO₄. From the viewpoint of increasing the charge-discharge efficiency of the aqueous battery, the type of the anode active material and the type of the sulfate used as the electrolyte may be selected so that, as described above, the metal element which is contained in the anode active material and which turns into a cation in the aqueous liquid electrolyte (that is, Zn, Cd, Fe, Sn, etc.) is the same metal element as the metal element which is contained in the sulfate used as the electrolyte and which turns into a cation in the aqueous liquid electrolyte (that is, Zn, Cd, Fe, Sn, etc.)

The concentration of the electrolyte in the aqueous liquid electrolyte can be appropriately determined depending on the properties of the desired battery, as long as the concentration does not exceed the saturation concentration of the electrolyte with respect to the solvent. This is because, when the electrolyte remains in a solid form in water, the solid electrolyte may interfere with battery reaction.

In general, as the concentration of the electrolyte in the aqueous liquid electrolyte increases, the potential window of the aqueous liquid electrolyte extends. However, since the viscosity of the solution increases, the ion conductivity of the aqueous liquid electrolyte tends to decrease. Accordingly, the concentration is generally determined depending on the properties of the desired battery, considering the potential window expanding effect and Li ion conductivity of the aqueous liquid electrolyte.

For example, in the case of using ZnSO₄ as the sulfate serving as the electrolyte, the content of the ZnSO₄ in the aqueous liquid electrolyte may be 1 mol or more per kg of the water. The upper limit of the content is not particularly limited. The content of the ZnSO₄ may be the saturation amount, or it may be 4 mol or less per kg of the water.

When the anode active material is at least one Zn-based material selected from the group consisting of an elemental Zn, a Zn alloy and ZnSO₄, from the viewpoint of suppressing the dissolution of the anode active material in the aqueous liquid electrolyte, the aqueous liquid electrolyte may contain ZnSO₄ as the sulfate. The concentration of the ZnSO₄ in the aqueous liquid electrolyte is not particularly limited, and the content of the ZnSO₄ may be 1 mol or more per kg of the water. The upper limit of the content is not particularly limited. The content may be the saturation amount, or it may be 4 mol or less per kg of the water.

When the anode active material is at least one Cd-based material selected from the group consisting of an elemental Cd, a Cd alloy and CdSO₄, from the viewpoint of suppressing the dissolution of the anode active material in the aqueous liquid electrolyte, the aqueous liquid electrolyte may contain CdSO₄ as the sulfate. The concentration of the CdSO₄ in the aqueous liquid electrolyte is not particularly limited, and the content of the CdSO₄ may be 1 mol or more per kg of the water. The upper limit of the content is not particularly limited, and the content may be the saturation amount.

When the anode active material is at least one Fe-based material selected from the group consisting of an elemental Fe, an Fe alloy and FeSO₄, from the viewpoint of suppressing the dissolution of the anode active material in the aqueous liquid electrolyte, the aqueous liquid electrolyte may contain FeSO₄ as the sulfate. The concentration of the FeSO₄ in the aqueous liquid electrolyte is not particularly limited, and the content of the FeSO₄ may be 1 mol or more per kg of the water. The upper limit of the content is not particularly limited, and the content may be the saturation amount.

When the anode active material is at least one Sn-based material selected from the group consisting of an elemental Sn, an Sn alloy and Sn₅O₄, from the viewpoint of suppressing the dissolution of the anode active material in the aqueous liquid electrolyte, the aqueous liquid electrolyte may contain Sn₅O₄ as the sulfate. The concentration of the Sn₅O₄ in the aqueous liquid electrolyte is not particularly limited, and the content of the Sn₅O₄ may be 1 mol or more per kg of the water. The upper limit of the content is not particularly limited, and the content may be the saturation amount.

From the viewpoint of suppressing the charge-discharge efficiency of the aqueous battery, the anode active material may be at least one Zn-based material selected from the group consisting of an elemental Zn, a Zn alloy and ZnSO₄, and the sulfate may be ZnSO₄.

In addition to the solvent and the electrolyte, the aqueous liquid electrolyte may contain other component. For example, to control the pH of the aqueous liquid electrolyte, the aqueous liquid electrolyte may contain lithium hydroxide, potassium hydroxide, sulfuric acid, etc.

From the viewpoint of causing desired charge and discharge reactions, the pH of the aqueous liquid electrolyte may be 3 or more and 14 or less. When the pH is more than 14, the sulfate such as ZnSO₄ is hardly soluble in the aqueous liquid electrolyte. As a result, the concentration of the sulfuric acid ions (reactive species) in the aqueous liquid electrolyte is too low, and there is a possibility that desired charge and discharge reactions do not occur.

(4) Other Components

In the aqueous battery of the disclosed embodiments, a separator may be disposed between the anode layer and the cathode layer. The separator functions to prevent contact between the cathode and the anode and to form an electrolyte layer by retaining the aqueous liquid electrolyte.

The separator may be a separator that is generally used in aqueous batteries. As the separator, examples include, but are not limited to, cellulose-based nonwoven fabric and resins such as polyethylene (PE), polypropylene (PP), polyester and polyamide.

The thickness of the separator is not particularly limited. For example, a separator having a thickness of 5 μm or more and 1 mm or less can be used.

As needed, the aqueous battery of the disclosed embodiments comprises an outer casing (battery casing) for housing the cathode, the anode and the aqueous liquid electrolyte.

The material for the outer casing is not particularly limited, as long as it is stable in electrolyte. As the material, examples include, but are not limited to, resins such as polypropylene, polyethylene and acrylic resin.

The aqueous battery of the disclosed embodiments may be a battery configured to use sulfuric acid ions as carrier ions. Cations serving as the counterions of the sulfuric acid ions, are not particularly limited. The cations may be zinc ions, cadmium ions, tin ions, iron ions or the like.

When an elemental Zn, a Zn alloy, ZnSO₄ are used as the anode active material, the electromotive force of the aqueous battery is about 2 V. When at least one selected from the group consisting of an elemental Cd, an elemental Fe, an elemental Sn, a Cd alloy, an Fe alloy, an Sn alloy, CdSO₄, FeSO₄ and Sn₅O₄ is used as the anode active material, the electromotive force is about 1.3 V.

The aqueous battery may be a primary battery or a secondary battery. The aqueous battery may be the latter, since it can be repeatedly charged and discharged and is useful as a car battery, for example. The term “secondary battery” encompasses the use of the secondary battery as a primary battery (i.e., the case where the secondary battery is charged and discharged only once).

As the form of the aqueous battery, examples include, but are not limited to, a coin form, a laminate form, a cylindrical form and a square form.

FIG. 2 shows a schematic view of the reaction mechanism of a graphite-ZnSO₄ aqueous battery.

When the aqueous battery of the disclosed embodiments is a graphite-ZnSO₄ aqueous battery comprising graphite as the cathode active material, a mixture of an elemental Zn and ZnSO₄ as the anode active material, and an aqueous liquid electrolyte containing ZnSO₄ as the electrolyte, the reaction is thought to be as follows.

In the aqueous liquid electrolyte, the ZnSO₄ exists as Zn²⁺ and SO₄²⁻. When the aqueous battery is charged, the Zn²⁺ in the aqueous liquid electrolyte precipitates as an elemental Zn in the anode, and the SO₄²⁻ in the aqueous liquid electrolyte is inserted between the graphite layers of the cathode. To maintain solution equilibrium, the ZnSO₄ in the anode dissolves in the aqueous liquid electrolyte and turns into Zn²⁺ and SO₄²⁻. Accordingly, the concentration of the ZnSO₄ in the aqueous liquid electrolyte is kept constant.

When the aqueous battery is discharged, the SO₄²⁻ is extracted from the graphite layers of the cathode, and in the anode, the elemental Zn is oxidized and dissolved to turn into a Zn²⁺ hydrate. Accordingly, the elemental Zn dissolves into the aqueous liquid electrolyte. When the saturation concentration of the aqueous liquid electrolyte is exceeded, it precipitates as ZnSO₄ in the anode. Accordingly, the concentration of the ZnSO₄ in the aqueous liquid electrolyte is kept constant.

Due to the above reasons, it is thought that the ZnSO₄ in the anode can be dissolved in the aqueous liquid electrolyte and precipitated in the anode by charging and discharging the aqueous battery, and the aqueous battery can function as a battery, accordingly. Even when a mixture of a Zn alloy and ZnSO₄ is used as the anode active material in place of the mixture of the elemental Zn and the ZnSO₄, since the Zn alloy contains a Zn element, the aqueous battery is thought to function as a battery, as well as the case of using the mixture of the elemental Zn and the ZnSO₄.

Due to the same reaction mechanism as that of the graphite-ZnSO₄ aqueous battery, all of the graphite-CdSO₄ aqueous battery comprising the elemental Cd and/or the mixture of the Cd alloy and the CdSO₄, the graphite-FeSO₄ aqueous battery comprising the elemental Fe and/or the mixture of the Fe alloy and the FeSO₄, and the graphite-SnSO₄ aqueous battery comprising the elemental Sn and/or the mixture of the Sn alloy and the Sn₅O₄, are thought to function as a battery.

The aqueous battery of the disclosed embodiments can be produced by employing a known method. For example, it can be produced as follows. However, the method for producing the aqueous battery of the disclosed embodiments is not limited to the following method.

(1) The anode active material for forming the anode layer, etc., are dispersed in a solvent to obtain a slurry for an anode layer. The solvent used here is not particularly limited. As the solvent, examples include, but are not limited to, water and various kinds of organic solvents. The solvent may be N-methylpyrrolidone (NMP). Then, using a doctor blade or the like, the slurry for the anode layer is applied to a surface of the anode current collector. The applied slurry is dried to form the anode layer on the surface of the anode current collector, thereby obtaining the anode.

(2) The cathode active material for forming the cathode layer, etc., are dispersed in a solvent to obtain a slurry for a cathode layer. The solvent used here is not particularly limited. As the solvent, examples include, but are not limited to, water and various kinds of organic solvents. The solvent may be N-methylpyrrolidone (NMP). Using a doctor blade or the like, the slurry for the cathode layer is applied to a surface of the cathode current collector. The applied slurry is dried to form the cathode layer on the surface of the cathode current collector, thereby obtaining the cathode.

(3) The separator is sandwiched between the anode and the cathode to obtain a stack of the anode current collector, the anode layer, the separator, the cathode layer and the cathode current collector, which are stacked in this order. As needed, other components such as a terminal are attached to the stack.

(4) The stack is housed in the battery casing, and the battery casing is filled with the aqueous liquid electrolyte. The battery casing containing the stack and the aqueous liquid electrolyte is hermetically closed so that the stack is immersed in the aqueous liquid electrolyte, thereby obtaining the aqueous battery.

### EXAMPLES

The following tests were carried out to check the operation of an aqueous battery comprising a cathode layer that contains a graphite as a cathode active material, an anode layer that contains zinc as an anode active material, and an aqueous liquid electrolyte that contains ZnSO₄ as an electrolyte, and to measure the battery voltage thereof.

### Example 1

[Production of Cathode-Side Evaluation Cell]

HOPG (SPY-1 grade, diameter 5 mm) was used as a working electrode.

A Zn foil (manufactured by Nilaco Corporation, diameter 10 mm) was used as a counter electrode.

Ag/AgCl (manufactured by International Chemistry Co., Ltd.) was used as a reference electrode.

A ZnSO₄ aqueous solution at a concentration of 1 mol/kg (pH 5.0) was used as an aqueous liquid electrolyte.

A three-electrode symmetric cell (manufactured by EC Frontier Co., Ltd.) was used as a battery evaluation cell.

The three-electrode symmetric cell was combined with the working, counter and reference electrodes. The aqueous liquid electrolyte was injected into the three-electrode symmetric cell, thereby producing the cathode-side evaluation cell of Example 1.

[Evaluation of the Cathode-Side Evaluation Cell]

Using a potentiostat (“VMP3” manufactured by BioLogic), cyclic voltammetry (CV) measurement of the cathode-side evaluation cell of Example 1 was carried out in a thermostat bath at 25° C.

Potential sweeping was carried out at a sweep rate of 10 mV/s from the open circuit potential (OCP) to the noble potential side (anode side) of the working electrode, until the potential of the working electrode reached 1.2 V vs. Ag/AgCl. Then, the sweep direction of the potential sweeping was reversed to the base potential side (cathode side), and the potential sweeping was carried out at a sweep rate of 10 mV/s until the potential of the working electrode reached the OCP. A combination of the sweeping from the OCP to 1.2 V vs. Ag/AgCl and the sweeping from 1.2 V vs. Ag/AgCl to the OCP was determined as one cycle. This potential sweeping was carried out for 10 cycles, and the cathode-side reaction potential was measured by use of the cyclic voltammogram of the third cycle, which showed a stable waveform. The result is shown in Table 1. The cathode-side reaction potential was determined as the average (E_{1/2}) of the oxidation-side reaction potential showed by the oxidation-side current peak and the reduction-side reaction potential showed by the reduction-side current peak, both of which were measured from the cyclic voltammogram.

FIG. 3 shows a cyclic voltammogram of the third cycle of CV cycles carried out at 10 mV/s on the cathode-side evaluation cell of Example 1, the cell comprising the ZnSO₄ aqueous solution at a concentration of 1 mol/kg.

By carrying out the CV measurement of the cathode-side evaluation cell, it was confirmed that insertion and extraction reactions of sulfuric acid ions between the graphite layers in the aqueous liquid electrolyte, occur.

[Production of Anode-Side Evaluation Cell]

An Sn foil (manufactured by Nilaco Corporation, diameter 13 mm) was used as a working electrode.

A Zn foil (manufactured by Nilaco Corporation, diameter 13 mm) was used as a counter electrode.

Ag/AgCl (manufactured by International Chemistry Co., Ltd.) was used as a reference electrode.

A ZnSO₄ aqueous solution at a concentration of 1 mol/kg (pH 5.0) was used as an aqueous liquid electrolyte.

A three-electrode symmetric cell (manufactured by EC Frontier Co., Ltd.) was used as a battery evaluation cell.

The three-electrode symmetric cell was combined with the working, counter and reference electrodes. The aqueous liquid electrolyte was injected into the three-electrode symmetric cell, thereby producing the anode-side evaluation cell of Example 1.

[Evaluation of the Anode-Side Evaluation Cell]

Using the potentiostat (“VMP3” manufactured by BioLogic), CV measurement of the anode-side evaluation cell of Example 1 was carried out in a thermostat bath at 25° C.

Potential sweeping was carried out at a sweep rate of 10 mV/s from the open circuit potential (OCP) to the base potential side (cathode side) of the working electrode, until the potential of the working electrode reached −1.2 V vs. Ag/AgCl. Then, the sweep direction of the potential sweeping was reversed to the noble potential side (anode side), and the potential sweeping was carried out at a sweep rate of 10 mV/s until the potential of the working electrode reached the OCP. A combination of the sweeping from the OCP to −1.2 V vs. Ag/AgCl and the sweeping from −1.2 V vs. Ag/AgCl to the OCP was determined as one cycle. This potential sweeping was carried out for 10 cycles, and the anode-side reaction potential was measured by use of the cyclic voltammogram of the third cycle, which showed a stable waveform. The result is shown in Table 1.

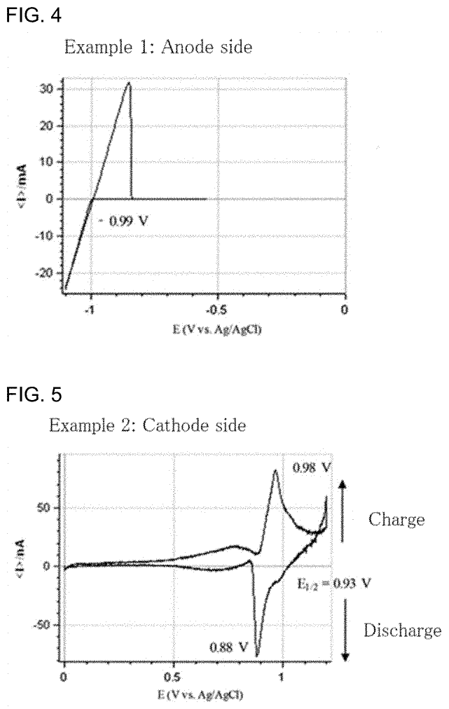

FIG. 4 shows a cyclic voltammogram of the third cycle of 10 CV measurement cycles carried out at 10 mV/s on the anode-side evaluation cell of Example 1, the cell comprising the ZnSO₄ aqueous solution at a concentration of 1 mol/kg.

By carrying out the CV measurement of the anode-side evaluation cell, zinc deposition, which is a basic reaction at the anode side of the aqueous battery, was confirmed on the surface of the working electrode. Also, the potential at which a zinc dissolution-deposition reaction on the surface of the working electrode, which corresponds to an anode current collector, proceeds (i.e., the anode-side reaction potential) was confirmed.

[Battery Voltage]

The battery voltage of the aqueous battery was calculated from the difference between the obtained cathode-side and anode-side reaction potentials. As a result, it was confirmed that the aqueous battery comprising the cathode layer containing HOPG as the cathode active material, the anode layer containing zinc as the anode active material, and the aqueous liquid electrolyte containing ZnSO₄ at a concentration of 1 mol/kg as the electrolyte, is operable at a battery voltage of 2.08 V. The result is shown in Table 1.

### Example 2

[Production of Cathode-Side Evaluation Cell]

The cathode-side evaluation cell of Example 2 was produced in the same manner as Example 1, except that a ZnSO₄ aqueous solution at a concentration of 2 mol/kg (pH 4.7) was used as the aqueous liquid electrolyte. [Evaluation of the cathode-side evaluation cell]

In the same manner as Example 1, CV measurement of the cathode-side evaluation cell of Example 2 was carried out, and the cathode-side reaction potential thereof was measured. The result is shown in Table 1.

FIG. 5 shows a cyclic voltammogram of the third cycle of CV cycles carried out at 10 mV/s on the cathode-side evaluation cell of Example 2, the cell comprising the ZnSO₄ aqueous solution at a concentration of 2 mol/kg.

By carrying out the CV measurement of the cathode-side evaluation cell, it was confirmed that insertion and extraction reactions of sulfuric acid ions between the graphite layers in the aqueous liquid electrolyte, occur.

[Production of Anode-Side Evaluation Cell]

The anode-side evaluation cell of Example 2 was produced in the same manner as Example 1, except that a ZnSO₄ aqueous solution at a concentration of 2 mol/kg (pH 4.7) was used as the aqueous liquid electrolyte. [Evaluation of the anode-side evaluation cell]

In the same manner as Example 1, CV measurement of the anode-side evaluation cell of Example 2 was carried out, and the anode-side reaction potential thereof was measured. The result is shown in Table 1.

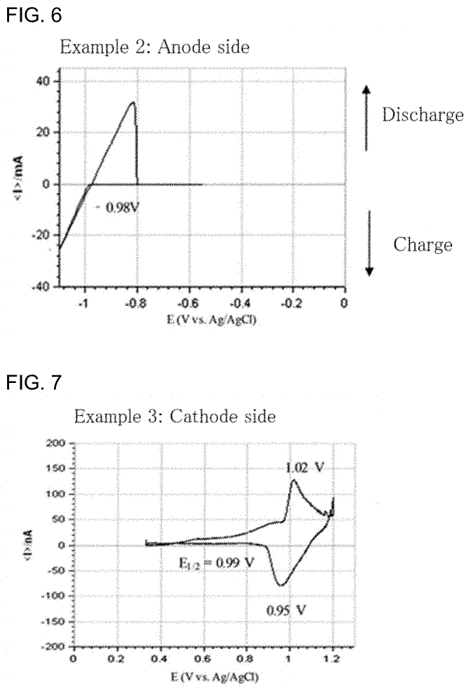

FIG. 6 shows a cyclic voltammogram of the third cycle of 10 CV measurement cycles carried out at 10 mV/s on the anode-side evaluation cell of Example 2, the cell comprising the ZnSO₄ aqueous solution at a concentration of 2 mol/kg.

By carrying out the CV measurement of the anode-side evaluation cell, zinc deposition, which is a basic reaction at the anode side of the aqueous battery, was confirmed on the surface of the working electrode. Also, the potential at which a zinc dissolution-deposition reaction on the surface of the working electrode, which corresponds to the anode current collector, proceeds (i.e., the anode-side reaction potential) was confirmed.

[Battery Voltage]

The battery voltage of the aqueous battery was calculated from the difference between the obtained cathode-side and anode-side reaction potentials. As a result, it was confirmed that the aqueous battery comprising the cathode layer containing HOPG as the cathode active material, the anode layer containing zinc as the anode active material, and the aqueous liquid electrolyte containing ZnSO₄ at a concentration of 2 mol/kg as the electrolyte, is operable at a battery voltage of 1.91 V. The result is shown in Table 1.

### Example 3

[Production of Cathode-Side Evaluation Cell]

The cathode-side evaluation cell of Example 3 was produced in the same manner as Example 1, except that a ZnSO₄ aqueous solution at a concentration of 3 mol/kg (pH 4.3) was used as the aqueous liquid electrolyte. [Evaluation of the cathode-side evaluation cell]

In the same manner as Example 1, CV measurement of the cathode-side evaluation cell of Example 3 was carried out, and the cathode-side reaction potential thereof was measured. The result is shown in Table 1.

FIG. 7 shows a cyclic voltammogram of the third cycle of CV cycles carried out at 10 mV/s on the cathode-side evaluation cell of Example 3, the cell comprising the ZnSO₄ aqueous solution at a concentration of 3 mol/kg.

By carrying out the CV measurement of the cathode-side evaluation cell, it was confirmed that insertion and extraction reactions of sulfuric acid ions between the graphite layers in the aqueous liquid electrolyte, occur.

[Production of Anode-Side Evaluation Cell]

The anode-side evaluation cell of Example 3 was produced in the same manner as Example 1, except that a ZnSO₄ aqueous solution at a concentration of 3 mol/kg (pH 4.3) was used as the aqueous liquid electrolyte.

[Evaluation of the Anode-Side Evaluation Cell]

In the same manner as Example 1, CV measurement of the anode-side evaluation cell of Example 3 was carried out, and the anode-side reaction potential thereof was measured. The result is shown in Table 1.

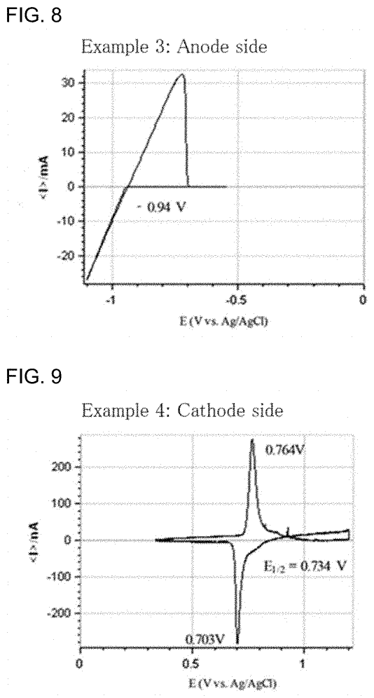

FIG. 8 shows a cyclic voltammogram of the third cycle of 10 CV measurement cycles carried out at 10 mV/s on the anode-side evaluation cell of Example 3, the cell comprising the ZnSO₄ aqueous solution at a concentration of 3 mol/kg.

By carrying out the CV measurement of the anode-side evaluation cell, zinc deposition, which is a basic reaction at the anode side of the aqueous battery, was confirmed on the surface of the working electrode. Also, the potential at which a zinc dissolution-deposition reaction on the surface of the working electrode, which corresponds to the anode current collector, proceeds (i.e., the anode-side reaction potential) was confirmed.

[Battery Voltage]

The battery voltage of the aqueous battery was calculated from the difference between the obtained cathode-side and anode-side reaction potentials. As a result, it was confirmed that the aqueous battery comprising the cathode layer containing HOPG as the cathode active material, the anode layer containing zinc as the anode active material, and the aqueous liquid electrolyte containing ZnSO₄ at a concentration of 3 mol/kg as the electrolyte, is operable at a battery voltage of 1.92 V. The result is shown in Table 1.

### Example 4

[Production of Cathode-Side Evaluation Cell]

The cathode-side evaluation cell of Example 4 was produced in the same manner as Example 1, except that a ZnSO₄ aqueous solution at a concentration of 4 mol/kg (pH 3.8) was used as the aqueous liquid electrolyte.

[Evaluation of the Cathode-Side Evaluation Cell]

In the same manner as Example 1, CV measurement of the cathode-side evaluation cell of Example 4 was carried out, and the cathode-side reaction potential thereof was measured. The result is shown in Table 1.

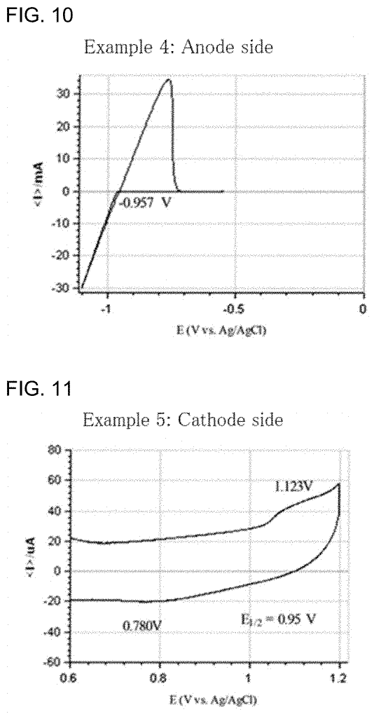

FIG. 9 shows a cyclic voltammogram of the third cycle of CV cycles carried out at 10 mV/s on the cathode-side evaluation cell of Example 4, the cell comprising the ZnSO₄ aqueous solution at a concentration of 4 mol/kg.

By carrying out the CV measurement of the cathode-side evaluation cell, it was confirmed that insertion and extraction reactions of sulfuric acid ions between the graphite layers in the aqueous liquid electrolyte, occur.

[Production of Anode-Side Evaluation Cell]

The anode-side evaluation cell of Example 4 was produced in the same manner as Example 1, except that a ZnSO₄ aqueous solution at a concentration of 4 mol/kg (pH 3.8) was used as the aqueous liquid electrolyte.

[Evaluation of the Anode-Side Evaluation Cell]

In the same manner as Example 1, CV measurement of the anode-side evaluation cell of Example 4 was carried out, and the anode-side reaction potential thereof was measured. The result is shown in Table 1.

FIG. 10 shows a cyclic voltammogram of the third cycle of 10 CV measurement cycles carried out at 10 mV/s on the anode-side evaluation cell of Example 4, the cell comprising the ZnSO₄ aqueous solution at a concentration of 4 mol/kg.

By carrying out the CV measurement of the anode-side evaluation cell, zinc deposition, which is a basic reaction at the anode side of the aqueous battery, was confirmed on the surface of the working electrode. Also, the potential at which a zinc dissolution-deposition reaction on the surface of the working electrode, which corresponds to the anode current collector, proceeds (i.e., the anode-side reaction potential) was confirmed.

[Battery Voltage]

The battery voltage of the aqueous battery was calculated from the difference between the obtained cathode-side and anode-side reaction potentials. As a result, it was confirmed that the aqueous battery comprising the cathode layer containing HOPG as the cathode active material, the anode layer containing zinc as the anode active material, and the aqueous liquid electrolyte containing ZnSO₄ at a concentration of 4 mol/kg as the electrolyte, is operable at a battery voltage of 1.69 V. The result is shown in Table 1.

### Example 5

[Production of Cathode-Side Evaluation Cell]

Natural graphite powder particles were prepared as a graphite. As a binder, PVDF (#9305 manufactured by Kureha Corporation) was prepared. The graphite and the PVDF were mixed at a mass ratio of 95:5. A mixture thus obtained was formed into a paste, using N-methylpyrrolidone (NMP) (manufactured by Kishida Chemical Co., Ltd.) as a solvent. The paste was applied on a Ti current collecting foil (manufactured by Rikazai Co., Ltd., thickness 15 μm) that the overvoltage of an oxygen evolution reaction (OER) was large, thereby obtaining an electrode (a natural graphite-applied electrode). The electrode was used as a working electrode (diameter 13 mm).

A ZnSO₄ aqueous solution at a concentration of 4 mol/kg was used as an aqueous liquid electrolyte.

A Zn foil (manufactured by Nilaco Corporation, diameter 13 mm) was used as a counter electrode.

Ag/AgCl (manufactured by International Chemistry Co., Ltd.) was used as a reference electrode.

A three-electrode symmetric cell (manufactured by EC Frontier Co., Ltd.) was used as a battery evaluation cell.

The three-electrode symmetric cell was combined with the working, counter and reference electrodes. The aqueous liquid electrolyte was injected into the three-electrode symmetric cell, thereby producing the cathode-side evaluation cell of Example 5.

[Evaluation of the Cathode-Side Evaluation Cell]

Potential sweeping was carried out for 20 cycles. In the same manner as Example 1, CV measurement of the cathode-side evaluation cell of Example 5 was carried out, and the cathode-side reaction potential thereof was measured, except that the cyclic voltammogram of the 20th cycle was used, at which an oxygen evolution reaction (OER) caused as a side reaction was moderated. The result is shown in Table 1.

FIG. 11 shows a cyclic voltammogram of the 20th cycle of CV cycles carried out at 10 mV/s on the cathode-side evaluation cell of Example 5, the cell comprising the natural graphite-applied electrode and the ZnSO₄ aqueous solution at a concentration of 4 mol/kg.

In FIG. 11, an oxidation-side current peak was confirmed around an oxidation-side potential of 1.123 V vs. Ag/AgCl, which is a slight peak. Also in FIG. 11, a reduction-side current peak was confirmed around a reduction-side potential of 0.780 V vs. Ag/AgCl, which is a slight peak and thought to be a peak derived from the reaction of sulfuric acid ions. Accordingly, by carrying out the CV measurement of the cathode-side evaluation cell, it was confirmed that insertion and extraction reactions of sulfuric acid ions between the graphite layers in the aqueous liquid electrolyte, occur.

For the natural graphite powder electrode, myriad structural defects are present on the surface of the natural graphite particles, compared to a HOPG electrode. Accordingly, changes such as a decrease in the reaction activity of the sulfuric acid ions to the natural graphite and an increase in the oxygen evolution reaction activity of the natural graphite, are thought to occur. Accordingly, it is estimated that the oxidation-side and reduction-side current peaks as shown by the HOPG electrode did not appear, and the current peaks were broad peaks and showed a large peak separation.

[Production of Anode-Side Evaluation Cell]

The anode-side evaluation cell of Example 5 was produced in the same manner as Example 4.

[Evaluation of the Anode-Side Evaluation Cell]

Since the anode-side evaluation cell of Example 5 had the same structure as the anode-side evaluation cell of Example 4, the anode-side evaluation cell of Example 5 obtained the same anode-side reaction potential as the anode-side evaluation cell of Example 4. The result is shown in Table 1.

[Battery Voltage]

The battery voltage of the aqueous battery was calculated from the difference between the obtained cathode-side and anode-side reaction potentials. As a result, it was confirmed that the aqueous battery comprising the cathode layer containing natural graphite as the cathode active material, the anode layer containing zinc as the anode active material, and the aqueous liquid electrolyte containing ZnSO₄ at a concentration of 4 mol/kg as the electrolyte, is operable at a battery voltage of 1.91 V. The result is shown in Table 1.

### Example 6

[Production of Cathode-Side Evaluation Cell]

The cathode-side evaluation cell of Example 6 was produced in the same manner as Example 1, except for the following.

A mercury/mercury oxide electrode (Hg/HgO manufactured by International Chemistry Co., Ltd.) was used as a reference electrode.

An aqueous solution containing KOH at a concentration of 1 mol/L and ZnSO₄ at a concentration of 1 mol/kg (pH 14) was used as an aqueous liquid electrolyte.

[Evaluation of the Cathode-Side Evaluation Cell]

In the same manner as Example 1, CV measurement of the cathode-side evaluation cell of Example 6 was carried out, and the cathode-side reaction potential thereof was measured. The result is shown in Table 1.

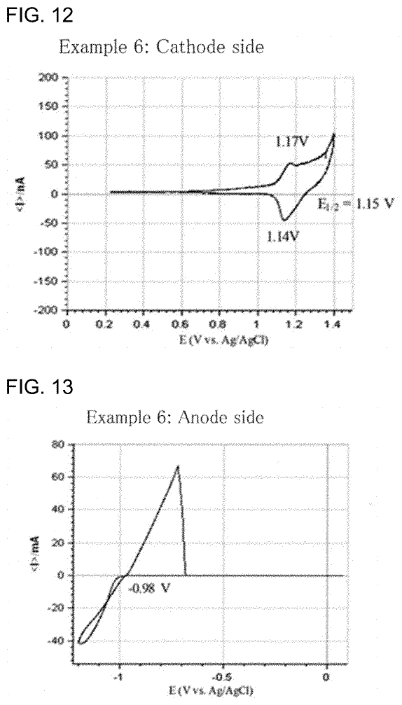

FIG. 12 shows a cyclic voltammogram of the third cycle of CV cycles carried out at 10 mV/s on the cathode-side evaluation cell of Example 6, the cell comprising the aqueous solution containing KOH at a concentration of 1 mol/L and ZnSO₄ at a concentration of 1 mol/kg.

By carrying out the CV measurement of the cathode-side evaluation cell, it was confirmed that insertion and extraction reactions of sulfuric acid ions between the graphite layers in the aqueous liquid electrolyte, occur. For the strong alkaline aqueous solution at a pH of 14, it was thought that the evolution potential of the oxygen evolution reaction, which is a side reaction at the cathode side, decreases to activate an oxygen evolution reaction, and oxidation-side and reduction-side current peaks do not appear in the cyclic voltammogram. However, as shown in FIG. 12, since the oxidation-side and reduction-side peaks were confirmed, it is estimated that the oxygen evolution reaction was suppressed due to the presence of the sulfuric acid ions in the aqueous solution.

[Production of Anode-Side Evaluation Cell]

The anode-side evaluation cell of Example 6 was produced in the same manner as Example 1, except for the following.

A Cu foil (manufactured by Nilaco Corporation, diameter 13 mm) was used as a working electrode.

A mercury/mercury oxide electrode (Hg/HgO manufactured by International Chemistry Co., Ltd.) was used as a reference electrode.

An aqueous solution containing KOH at a concentration of 1 mol/L and ZnSO₄ at a concentration of 1 mol/kg (pH 14) was used as an aqueous liquid electrolyte.

[Evaluation of the Anode-Side Evaluation Cell]

In the same manner as Example 1, CV measurement of the anode-side evaluation cell of Example 6 was carried out, and the anode-side reaction potential thereof was measured. The result is shown in Table 1.

FIG. 13 shows a cyclic voltammogram of the third cycle of 10 CV measurement cycles carried out at 10 mV/s on the anode-side evaluation cell of Example 6, the cell comprising the aqueous solution containing KOH at a concentration of 1 mol/L and ZnSO₄ at a concentration of 1 mol/kg.

By carrying out the CV measurement of the anode-side evaluation cell, zinc deposition, which is a basic reaction at the anode side of the aqueous battery, was confirmed on the surface of the working electrode. Also, the potential at which a zinc dissolution-deposition reaction on the surface of the working electrode, which corresponds to an anode current collector, proceeds (i.e., the anode-side reaction potential) was confirmed.

[Battery Voltage]

The battery voltage of the aqueous battery was calculated from the difference between the obtained cathode-side and anode-side reaction potentials. As a result, it was confirmed that the aqueous battery comprising the cathode layer containing HOPG as the cathode active material, the anode layer containing zinc as the anode active material, and the aqueous liquid electrolyte containing KOH at a concentration of 1 mol/L and ZnSO₄ at a concentration of 1 mol/kg as the electrolyte, is operable at a battery voltage of 2.13 V. The result is shown in Table 1.

### Comparative Example 1

[Production of Cathode-Side Evaluation Cell]

In the same manner as Example 1, the cathode-side evaluation cell of Comparative Example 1 was produced, except that an aqueous solution containing H₂SO₄ at a concentration of 0.5 mol/L and ZnSO₄ at a concentration of 1 mol/kg (pH 2) was used as the aqueous liquid electrolyte.

[Evaluation of the Cathode-Side Evaluation Cell]

CV measurement of the cathode-side evaluation cell of Comparative Example 1 was carried out in the same manner as Example 1.

For the cathode-side evaluation cell of Comparative Example 1, insertion and extraction reactions of sulfuric acid ions between the graphite layers in the aqueous liquid electrolyte, was not confirmed.

[Production of Anode-Side Evaluation Cell]

An Au foil (manufactured by Nilaco Corporation, diameter 13 mm) was used as a working electrode.

The anode-side evaluation cell of Comparative Example 1 was produced in the same manner as Example 1, except that an aqueous solution containing H₂SO₄ at a concentration of 0.5 mol/L and ZnSO₄ at a concentration of 1 mol/kg (pH 2) was used as an aqueous liquid electrolyte.

[Evaluation of the Anode-Side Evaluation Cell]

CV measurement of the anode-side evaluation cell of Comparative Example 1 was carried out in the same manner as Example 1.

For the anode-side evaluation cell of Comparative Example 1, zinc deposition, which is a basic reaction at the anode side of the aqueous battery, was not confirmed on the surface of the Zn foil. The reason is estimated as follows: in the strong acid aqueous solution at a pH of 2, since the hydrogen evolution potential at the anode side increased, the zinc deposition and dissolution reaction on the anode active material surface and/or the anode current collector surface was inhibited.

[Battery Voltage]

Since the cathode-side and anode-side reaction potentials were unmeasurable, it was confirmed that the aqueous battery comprising the cathode layer containing HOPG as the cathode active material, the anode layer containing zinc as the anode active material, and the aqueous liquid electrolyte containing H₂SO₄ at a concentration of 0.5 mol/L and ZnSO₄ at a concentration of 1 mol/kg as the electrolyte, does not function as a battery. The result is shown in Table 1.

TABLE 1

| | | | | | | | | Reaction potential | | | | |
|---|---|---|---|---|---|---|---|---|---|---|---|---|
| | | | | | | | | (V vs. Reference electrode) | | | | |
| | | | Evaluation cell structure | | | | | | | | Anode | |
| | Aqueous liquid | | | Cathode side | | Anode side | | | | | side | Battery |
| | electrolyte | | Reference | Working | Counter | Working | Counter | Cathode side | | | Reaction | voltage |
| | Type | pH | electrode | electrode | electrode | electrode | electrode | Oxidation | Reduction | E_{1/2} | potential | (V) |
| Example 1 | 1 mol/kg | 5.0 | Ag/AgCl | HOPG | Zn foil | Sn foil | Zn foil | 1.112 | 1.077 | 1.09 | −0.99 | 2.08 |
| | ZnSO₄ | | | SPY-1 | | | | | | | | |
| Example 2 | 2 mol/kg | 4.7 | Ag/AgCl | HOPG | Zn foil | Sn foil | Zn foil | 0.980 | 0.880 | 0.93 | −0.98 | 1.91 |
| | ZnSO₄ | | | SPY-1 | | | | | | | | |
| Example 3 | 3 mol/kg | 4.3 | Ag/AgCl | HOPG | Zn foil | Sn foil | Zn foil | 1.016 | 0.954 | 0.98 | −0.94 | 1.92 |
| | ZnSO₄ | | | SPY-1 | | | | | | | | |
| Example 4 | 4 mol/kg | 3.8 | Ag/AgCl | HOPG | Zn foil | Sn foil | Zn foil | 0.764 | 0.703 | 0.73 | −0.96 | 1.69 |
| | ZnSO₄ | | | SPY-1 | | | | | | | | |
| | | | | Natural | | | | | | | | |
| Example 5 | 4 mol/kg | 3.8 | Ag/AgCl | graphite- | Zn foil | Sn foil | Zn foil | 1.123 | 0.780 | 0.95 | −0.96 | 1.91 |
| | ZnSO₄ | | | applied | | | | | | | | |
| | | | | electrode | | | | | | | | |
| Example 6 | 1 mol/L | 14.0 | Hg/HgO | HOPG | Zn foil | Cu foil | Zn foil | 1.169 | 1.135 | 1.15 | −0.98 | 2.13 |
| | KOH + 1 | | | SPY-1 | | | | | | | | |
| | mol/kg | | | | | | | | | | | |
| | ZnSO₄ | | | | | | | | | | | |

| | | | | | | | | |
|---|---|---|---|---|---|---|---|---|
| Comparative | 0.5 mol/L | 2.0 | Ag/AgCl | HOPG | Zn foil | Au foil | Zn foil | Unmeasurable |
| Example 1 | H₂SO₄ + 1 | | | SPY-1 | | | | |
| | mol/kg | | | | | | | |
| | ZnSO₄ | | | | | | | |

From the above results, it was confirmed that the aqueous battery comprising the cathode layer containing graphite as the cathode active material, the anode layer containing an elemental Zn as the anode active material, and the aqueous liquid electrolyte containing ZnSO₄ as the electrolyte, functions as a battery. Accordingly, even in the case of the aqueous battery in which, in place of the elemental Zn, at least one selected from the group consisting of a Zn alloy and ZnSO₄ is used as the anode active material, since these materials contain a Zn element, the aqueous battery is thought to function as a battery, as with the case of the aqueous battery comprising the elemental Zn as the anode active material.

Also, even in the case of the aqueous battery in which, in place of the elemental Zn, the above-described Cd-based material, Fe-based material and/or Sn-based material is used as the anode active material, since the Cd element, Fe element and/or Sn element contained in the materials turns into a cation in the aqueous liquid electrolyte used in the disclosed embodiments, the aqueous battery is thought to function as a battery, as with the case of the aqueous battery comprising the elemental Zn as the anode active material.

Even in the case of the aqueous battery in which at least one sulfate selected from the group consisting of CdSO₄, FeSO₄ and Sn₅O₄ is used as the electrolyte in place of ZnSO₄, since these sulfates produce sulfuric acid ions in the aqueous liquid electrolyte, the aqueous battery is thought to function as a battery, as with the case of the aqueous battery comprising ZnSO₄ as the electrolyte.

### REFERENCE SIGNS LIST

11. Aqueous liquid electrolyte
12. Cathode layer
13. Anode layer
14. Cathode current collector
15. Anode current collector
16. Cathode
17. Anode
100. Aqueous battery

1. An aqueous battery comprising a cathode layer, an anode layer and an aqueous liquid electrolyte,
wherein the cathode layer contains, as a cathode active material, a graphite;
wherein the anode layer contains, as an anode active material, at least one selected from the group consisting of an elemental Zn, an elemental Cd, an elemental Fe, an elemental Sn, a Zn alloy, a Cd alloy, an Fe alloy, an Sn alloy, ZnSO₄, CdSO₄, FeSO₄ and SnSO₄;
wherein, as an electrolyte, at least one sulfate selected from the group consisting of ZnSO₄, CdSO₄, FeSO₄ and SnSO₄ is dissolved in the aqueous liquid electrolyte; and
wherein the aqueous liquid electrolyte has a pH of 3 or more and 14 or less.

2. The aqueous battery according to claim 1, wherein the anode active material is at least one selected from the group consisting of an elemental Zn, a Zn alloy and ZnSO₄, and the sulfate is ZnSO₄; the anode active material is at least one selected from the group consisting of an elemental Cd, a Cd alloy and CdSO₄, and the sulfate is CdSO₄; the anode active material is at least one selected from the group consisting of an elemental Fe, an Fe alloy and FeSO₄, and the sulfate is FeSO₄; or the anode active material is at least one selected from the group consisting of an elemental Sn, an Sn alloy and SnSO₄, and the sulfate is SnSO₄.

3. The aqueous battery according to claim 1, wherein the anode active material is at least one selected from the group consisting of an elemental Zn, a Zn alloy and ZnSO₄.
